(19) United States
(12) Patent Application Publication
(10) Pub. No.: US 2016/0078743 A1
(43) Pub. Date: Mar. 17, 2016

(54) Remote Pipe Lining Air Monitoring System

(71) Applicant: Jeffrey M. Tanner, Zanesville, OH (US)

(72) Inventor: Jeffrey M. Tanner, Zanesville, OH (US)

(21) Appl. No.: 14/487,280

(22) Filed: Sep. 16, 2014

(51) Int. Cl. G08B 21/18; H04N 7/18; F16L 55/165

(52) U.S. Cl. CPC G08B 21/182; F16L 55/1654; H04N 7/183

(57) ABSTRACT

A remote pipe lining air monitoring system for remotely monitoring air pressure when curing a pipe liner. The present system generally includes a case storing an internal monitoring system. The case includes a port which is adapted to be fluidly connected in-line between an air compressor and a pipe liner. An internal compartment of the case includes the various components of the monitoring system, including a communications device, illumination device, air pressure monitor, alarm device, and a camera. The illumination device illuminates the internal compartment of the case while the camera is directed at the air pressure monitor. The communications device remotely transmits a video signal of the monitor to a remote device. In the event of pressure change or loss of power, the audio detector will detect activation of the alarm device and cause an alert to be transmitted to a remote device by the communications device.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to a remote monitoring system and more specifically it relates to a remote pipe lining air monitoring system for remotely monitoring air pressure when curing a pipe liner.

2. Description of the Related Art

Any discussion of the related art throughout the specification should in no way be considered as an admission that such related art is widely known or forms part of common general knowledge in the field.

Cured-in-place pipe (CIPP) liners have been used for many years for the rehabilitation of different types and sizes of conduit and piping systems such as utility, sewer, water, electric, telecom, industrial, petroleum, fire suppression, heating, cooling and the like. CIPP requires the liner to be expanded and cured using hot water, ambient air, steam or UV lights. When using ambient air pressure to expand and cure a pipe or conduit liner, it may require leaving the expanded liner for long periods of time before the thermosetting resin impregnated liner cures. This requires someone to constantly watch and monitor the air pressure so that the liner doesn't deflate and lose its shape. If the liner loses pressure and then cures, it would require cutting the liner out of the pipe or conduit. This would take a considerable amount of time and expense, it may also damage the existing pipe or conduit, therefore a constant monitoring is required to make sure the pressure is maintained.

There are air compressor systems and regulators that will provide a constant supply of air to the liner when utilizing ambient air curing, but these systems are not always reliable. Electrical failure may occur to the compressor as well as other mechanical failures may happen.

It is the intent of this invention to monitor the air pressure required to cure a cured-in-place-pipe or conduit liner without the need of having someone, such as a lining technician, to constantly be present during the ambient air pressure curing process of the liner. It is also the intent of this invention to remotely alert the technician if air pressure drops or increases inside of the curing liner. It is also the intent of this invention to allow the technician to remotely view the monitoring gauges at any given time during the curing of the liner.

Because of the inherent problems with the related art, there is a need for a new and improved remote pipe lining air monitoring system for remotely monitoring air pressure when curing a pipe liner.

### BRIEF SUMMARY OF THE INVENTION

The invention generally relates to a remote pipe lining monitoring system which includes a case storing an internal monitoring system. The case includes a port which is adapted to be fluidly connected in-line between an air compressor and a pipe liner. An internal compartment of the case includes the various components of the monitoring system, including a communications device, illumination device, air pressure monitor, alarm device, and a camera. The illumination device illuminates the internal compartment of the case while the camera is directed at the air pressure monitor. The communications device remotely transmits a video signal of the monitor to a remote device. In the event of pressure change or loss of power, the audio detector will detect activation of the alarm device and cause an alert to be transmitted to a remote device by the communications device.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto. In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a frontal upper perspective view of the present invention with the case closed.

FIG. 2 is a rear upper perspective view of the present invention with the case closed.

FIG. 3 is a frontal upper perspective view of the present invention with the case opened.

FIG. 4 is an upper perspective view of the present invention connected in-line with an air compressor.

FIG. 5 is a top view of the present invention with the case opened.

FIG. 6 is a side view of the present invention with the case closed.

FIG. 7 is a block diagram of the monitoring system of the present invention.

FIG. 8 is a flowchart illustrating initial setup and camera monitoring of the present invention.

FIG. 9 is a flowchart illustrating the detection and transmission of an alert related to power loss by the present invention.

FIG. 10 is a flowchart illustrating the detection and transmission of an alert related to unexpected pressure change by the present invention.

### DETAILED DESCRIPTION OF THE INVENTION

### A. Overview.

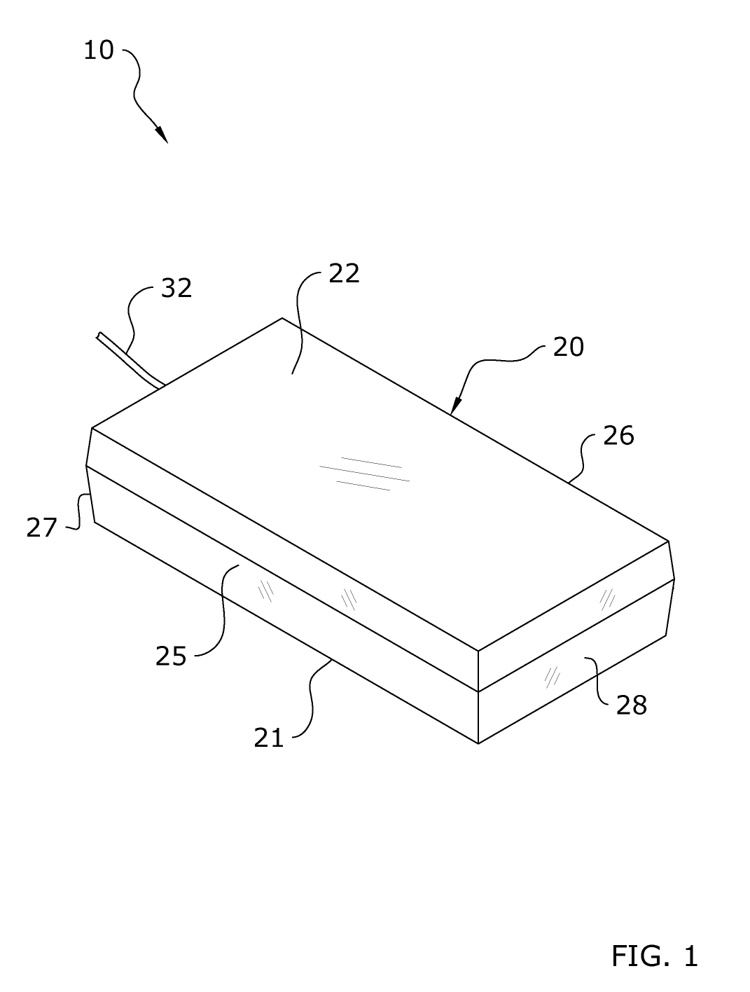

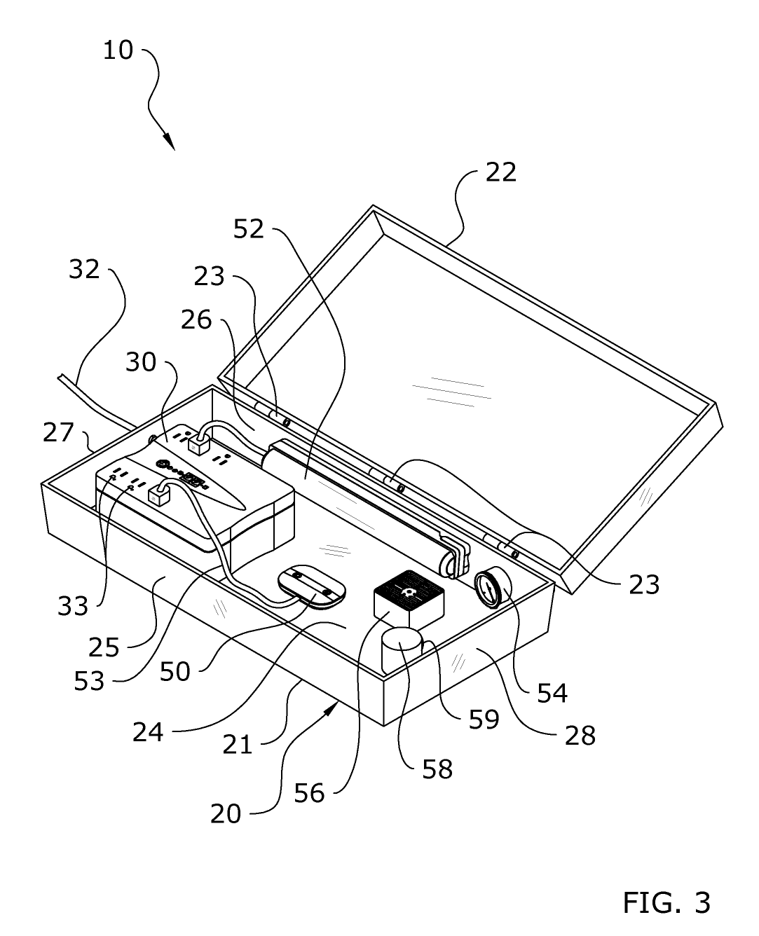

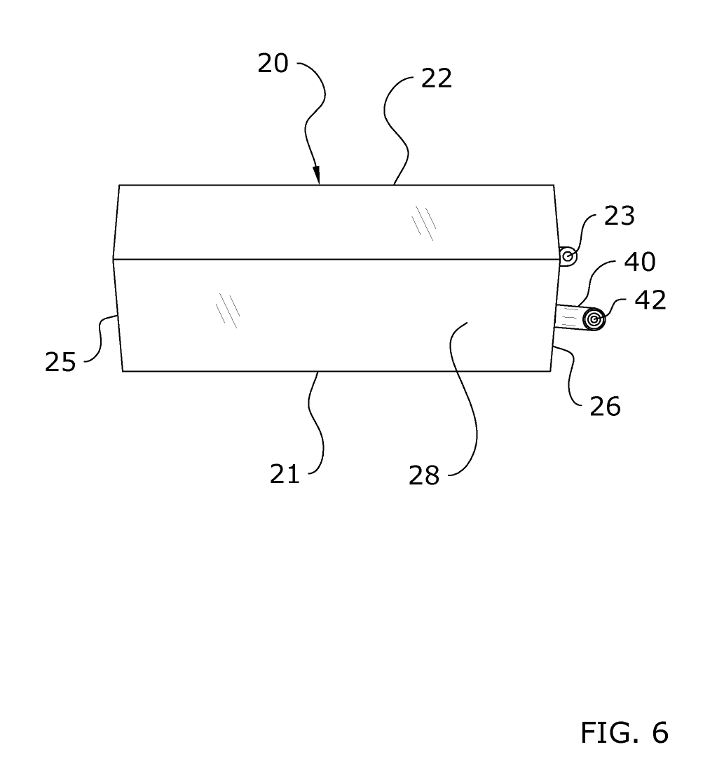

Turning now descriptively to the drawings, in which similar reference characters denote similar elements throughout the several views, FIGS. 1 through 10 illustrate a remote pipe lining air monitoring system 10, which comprises a case 20 storing an internal monitoring system. The case 20 includes a port 40 which is adapted to be fluidly connected in-line between an air compressor 12 and a pipe liner 15. An internal compartment 24 of the case 20 includes the various components of the monitoring system, including a communications device 50, illumination device 52, air pressure monitor 54, alarm device 56, an audio detector 57, and a camera 58. The illumination device 52 illuminates the internal compartment of the case 20 while the camera 58 is directed at the air pressure monitor 54. The communications device 50 remotely transmits a video signal of the monitor 54 to a remote device 18. In the event of pressure change or loss of power, the audio detector 57 will detect activation of the alarm device 56 and cause an alert to be transmitted to a remote device 18 by the communications device 50.

### B. Case.

The various components of the present invention may be included in an easily-transportable case 20 as shown throughout the figures. It should be appreciated at the outset, however, that the present invention may, in some embodiments, omit a discrete case 20 entirely. In such embodiments, the various components of the present invention described herein could be arranged without a case 20, such as within an existing enclosure. In a preferred embodiment as shown in the figures, a portable case 20 is utilized to aid in easily transporting the present invention between different work sites. The case 20 will generally include a front end 25, a rear end 26, a first side 27, and a second side 28, though this may vary if different shapes are utilized for the case 20. The structure, size, and configuration of the case 20 may vary in different embodiments. Thus, the configuration of the case 20 should not be construed as being limited by the exemplary figures.

In a preferred embodiment as best shown in FIGS. 1-3, the case 20 includes a base 21 and a cover 22 which selectively closes over the base 21. The cover 22 may be hingedly secured to the base 21, such as through use of a hinge 23 at the rear end 26 of the case 20 as shown in the figures. When the base 21 and cover 22 are secured together, an internal compartment 24 is defined which stores and protects the various components of the present invention as shown in the figures.

### C. Monitoring System.

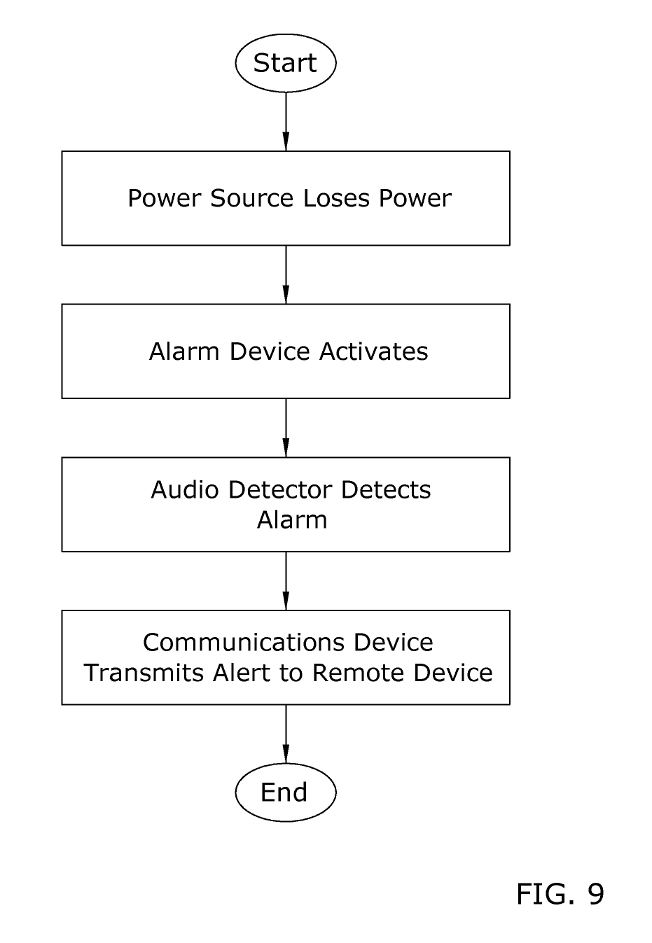

The case 20 of the present invention stores and protects the various components of a monitoring system which is included with the present invention. The monitoring system will act to ensure proper functioning of pipe lining systems (i.e. cured-in-place pipe lining systems and the like). For example, air pressure may be monitored to ensure that a liner does not deflate and lose its shape during the curing process. Additionally, power may be monitored to ensure that a loss of power does not similarly result in deflation of the liner. Although the configuration may vary, the monitoring system of the present invention will generally include a power source 30, a communications device 50, an illumination device 52, an air pressure monitor 54, an alarm device 56, an audio detector 57, and a camera 58 as shown in FIG. 9.

The monitoring system of the present invention generally includes a power source 30 which provides power to the various other components of the monitoring system described herein. It should be appreciated that various types of power sources 30 may be utilized with the present invention so long as the power source 30 provides the requisite power to operate the present invention. The power source 30 will preferably be adequate for long periods of operation and thus, in preferred embodiments, may include backup batteries or the like.

The power source 30 will preferably be of a compact enough size to fit within the internal compartment 24 of the case 20 along with the various other components of the monitoring system. The weight of the power source 30 should also preferably not be excessive to allow for ease-of-transport of the case 20 in such embodiments of the present invention. The illustrations show the power source 30 as being positioned adjacent to the first side 27 of the case 20, though it could be positioned in other locations, including outside of the case 20, so long as it does not obstruct the view from the camera lens 59 to the air pressure monitor 54.

The power source 30 may include an input conduit 32. The input conduit 32 will provide power to the power source 30. The power source 30 further distributes this power to the other components of the present invention. The input conduit 32 will preferably extend out of the case 20 (either through the base 21 as shown or through the cover 22) to be plugged into a main source of power such as a wall socket or generator. In embodiments in which the power source 30 is comprised of a battery, it should be appreciated that the input conduit 32 may be omitted.

In a preferred embodiment, the power source 30 will be comprised of an uninterruptable power supply (UPS). Such a configuration will allow for the input conduit 32 to be used to provide constant power to the power source 30, but will prevent the shutdown of the present invention in the event that the constant source of power is interrupted, such as through a power outage. Various types of uninterruptable power supplies known in the arts may be utilized for the present invention.

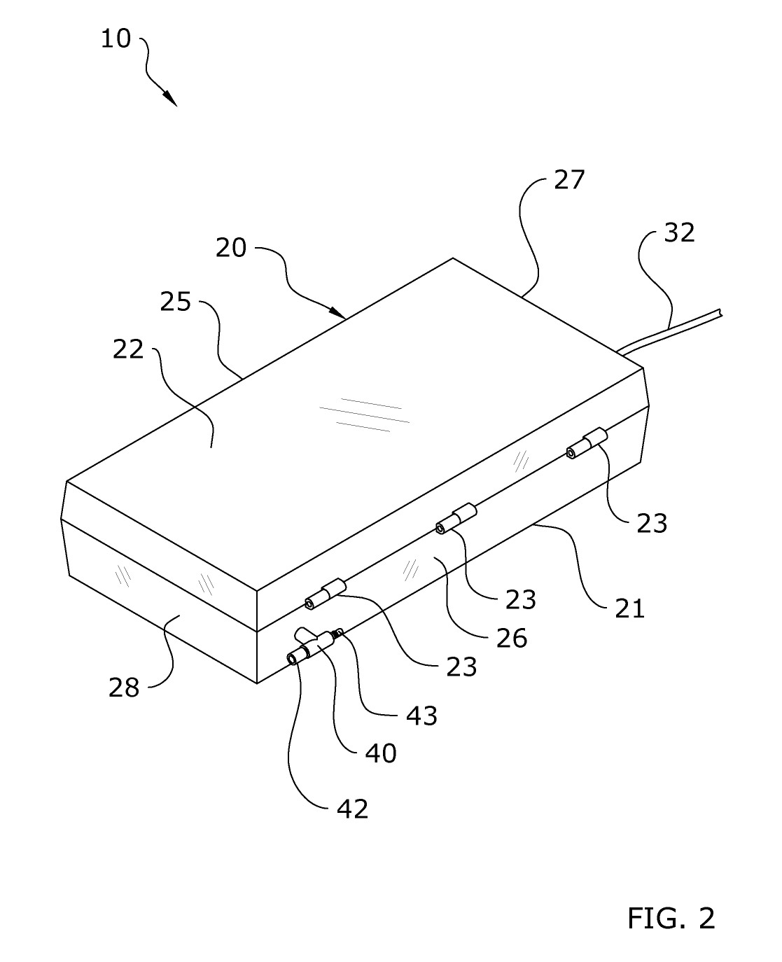

The power source 30 will act as a hub for the various components of the present invention. Some or all of the components of the monitoring system may be hard-wired into the power source 30 or, in alternate embodiments, may be plugged in to the power source 30 with an electrical plug such as a three-socket plug or two-socket plug. In such embodiments, the power source 30 may include a plurality of sockets 33 adapted to receive the plugs from the various components of the monitoring system as shown in FIG. 2.

The case 20 will generally include a port 40 so that the present invention may be installed in-line between an air compressor 12 and the pipe liner 15 being installed. The port 40 may be positioned at various locations on the case 20, such as at its rear end 26 as shown in the figures. This positioning should not be construed as limiting on the scope of the present invention, however.

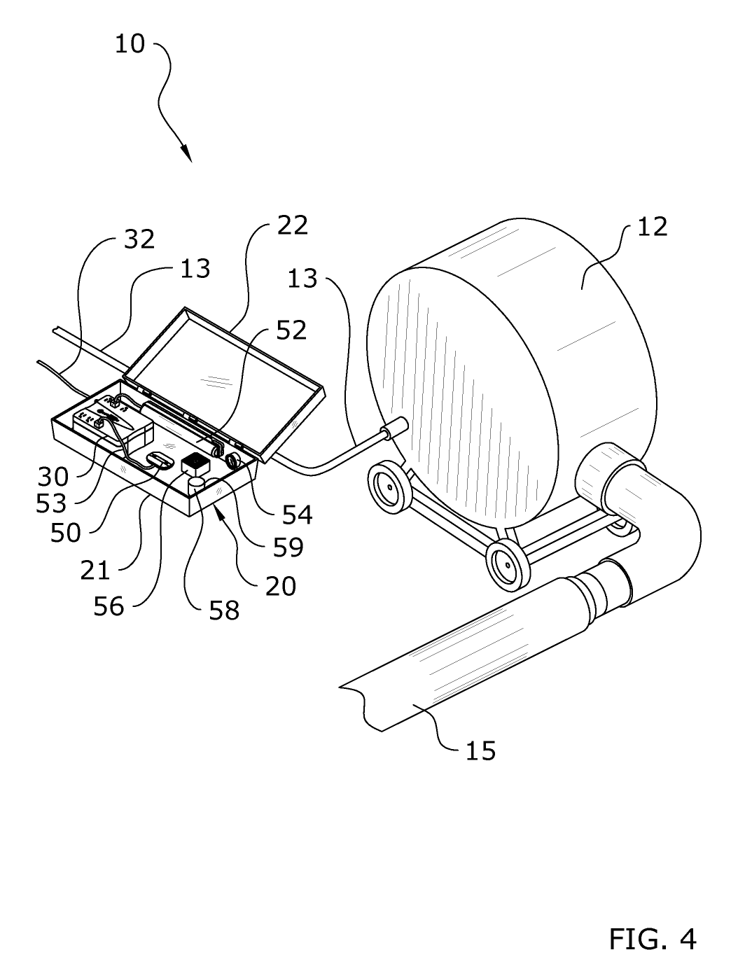

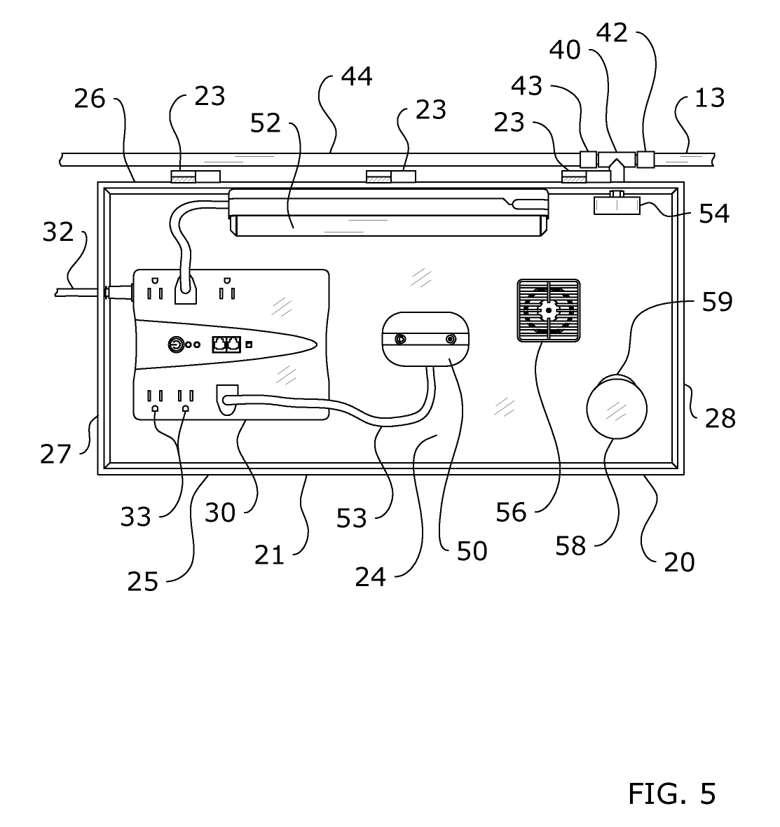

The port 40 will generally include an inlet 42 and an outlet 43 as best shown in FIG. 2. The inlet 42 of the port 40 is fluidly connected to the air compressor 12 via a first conduit 13 as shown in FIGS. 4 and 5. The outlet 43 of the port 40 is fluidly connected to an outlet conduit 44 which is inserted through the piping to blast compressed air into the liner 15 being installed.

The present invention will generally include a communications device 50 as best shown in FIG. 5. The communications device 50 will transmit video, audio, and other data signals wirelessly to a remote device 18. Thus, the communications device 50 will act as a link between the present invention and the remote device 18 so that the lining process may be remotely monitored without being present at the site.

The communications device 50 may be positioned at various locations on the present invention. In a preferred embodiment, the communications device 50 is positioned at a central location within the internal compartment 24 of the case 20. While the communications device 50 is illustrated as being positioned within the base 21, it should be appreciated that the communications device 50 could be positioned within the cover 22 or externally to the case 20 in some embodiments.

It should be appreciated that a wide range of communications devices 50 known in the art may be utilized with the present invention. In a preferred embodiment, the communications device 50 will comprise a compact transmitter such as a wireless router or the like which is communicatively interconnected through a wireless connection with a remote device 18.

A wide range of communications protocols may be utilized to effectuate the wireless communication between the communications device 50 and the remote device 18. In a preferred embodiment, the communications device 50 will comprise a router which is connected via WI-FI to a communications network such as the Internet. The remote device 18 may then be similarly connected to the Internet to receive data sent by the communications device 50. Various other protocols may be utilized, however, such as RFID, Bluetooth, and the like.

It should also be appreciated that any type of remote device 18 may be used with the present invention. Thus, the scope of the present invention should not be construed as being limited for use with any particular receiving device. By way of example and without limitation, such remote devices 18 may include computers, notebooks, tablets, smart phones, and the like.

The present invention may also include an illumination device 52 which ensures that the air pressure monitor 54 is sufficiently illuminated to be visible remotely via a remote display (e.g. smart phone, computer monitor) as it is monitored by the camera 58. Various types of illumination devices 52 may be utilized, including light-emitting-diodes (LED's), halogen lights, fluorescent lights, light bulbs, and the like. Any type of illumination devices 52 known in the art may be utilized so long as it fits within the case 20 and provides requisite illumination such that the air pressure monitor 54 is visible to the camera 58 in low light conditions or when the case 20 is closed.

The positioning of the illumination device 52 may vary in different embodiments. In the embodiment illustrated in FIG. 5, the illumination device 52 is positioned adjacent to the rear end 26 of the case 20. The illumination device 52 may instead be located anywhere within the case 20, including on the base 21 or on the cover 22, so long as the internal compartment is sufficiently illuminated for the camera 58 to function properly.

The illumination device 52 may be self-powered or may be connected to the power source 30, such as through a power cord 53 as shown in the figures. In some embodiments, the illumination device 52 may be secured to or integrally formed with the camera 58, such as is common with camera flashes.

The present invention includes an air pressure monitor 54 within the case 20. Various types of air pressure monitors 54 known in the art may be utilized and the scope of the present invention should not be limited to any particular type of monitor 54. The air pressure monitor 54 may be analog, digital, or combinations thereof. The air pressure monitor 54 is connected in-line with the lining system via the port 40 to monitor airflow there through, detect air pressure and detect loss of air pressure.

The present invention includes one or more alarm devices 56 for emitting an audible alert in the event of an unexpected change in pressure and/or loss of power. The number and positioning of the alarm device 56 may vary in different embodiments of the present invention. The type of alarm device 56 utilized may also vary. The alarm device 56 may be comprised of a simple speaker or may be comprised of a more complex alarming apparatus. The alarm device 56 may also include visual alert capabilities, such as a flashing light or the like, as a backup to the audible alarm.

In some embodiments, a single alarm device 56 will be adapted to emit an alarm upon either the air pressure monitor 54 detecting a change in pressure or the loss of power by the power source 30. In other embodiments, multiple alarm devices 56 may be utilized. For example, the air pressure monitor 54 could have its own first alarm device 56 while the power source 30 has its own discrete second alarm device 56.

It should also be appreciated that the alarm device 56 may be integrated with other components of the present invention in some embodiments. For example, a first alarm device 56 could comprise a speaker or other alarm integrated with the air pressure monitor 54 and a second alarm device 56 could comprise a speaker or other alarm integrated with the power source 30.

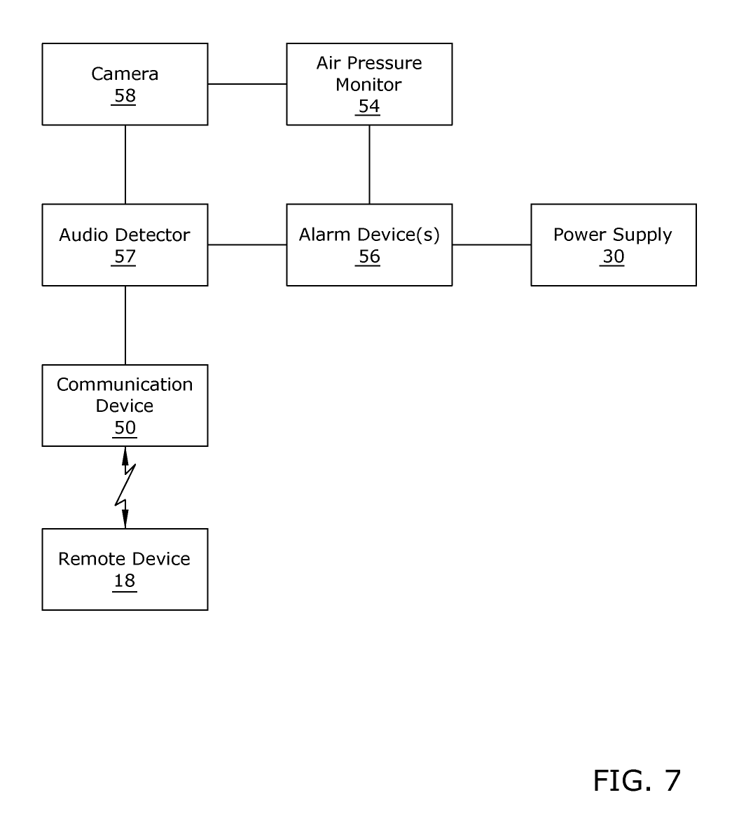

As best shown in FIG. 7, the present invention may include an audio detector 57 for detecting an audible alarm initiated by the alarm device 56, such as in response to a change in pressure or loss of power. Various types of audio detectors 57 may be utilized with the present invention, such as microphones and the like. In some embodiments, the audio detector 57 will be integrated with another component of the monitoring system. For example, the audio detector 57 may be comprised of a microphone integrated with the camera 58 of the present invention.

When an alarm is generated by the alarm device 56, the audio detector 57 will detect the sound being emitted by the alarm device 56. Upon the detection of such an alarm, the communications device 50 will activate to transmit an alert to the remote device 18 to inform any remotely monitoring technician of the change in conditions. This alert may take any number of forms, such as but not limited to a telephone call, email, text message (SMS or MMS), an instant message (such as through Skype, AIM, etc.), or a simple flashing light on the remote device 18.

As shown throughout the figures, the present invention also includes a camera 58. Various types of cameras 58 may be utilized. Preferably a video camera with audio detection capabilities (such as a microphone) will be utilized so that the audio detector 57 may be integrated with the camera 58, though other configurations may be utilized in different embodiments. The camera 58 will preferably be a compact, remote camera 58, such as commonly used for recreation or various monitoring systems (such as a baby monitor).

The camera 58 may be positioned at various locations and should not be construed as limited by the exemplary placement within the case 20 shown in the figures. However, the lens 59 of the camera 58 is preferably directed at the air pressure monitor 54 as is best shown in FIG. 5. This allows the camera 58 to constantly transmit a visual depiction of the air pressure monitor 54 via the communications device 50 to be viewed remotely by the remote device 18. The video signal from the camera 58 is thus preferably transmitted to the remote device 18 through usage of the communications device 50.

### D. Operation of Preferred Embodiment.

In use, the present invention is generally positioned at or near the air compressor 12 being utilized to feed pressurized air through the pipe liner 15 for expanding and curing against a pipe. The inlet 42 and outlet 43 of the port 40 are connected in-line between the air compressor 12 and the pipe liner 15 by securing a compressor conduit 13 to the inlet 42 and an outlet conduit 44 to the outlet 43.

After connecting the port 40 in line with the air compressor 12, the present invention may be powered on. The input conduit 32 for the power source 30, if present, may be connected to a wall socket, generator, or other supply of power. In some embodiments, this step will be unnecessary, such as when the power source 30 comprises a battery without need for an external power supply.

The case 20 may be opened to configure the various components for remote monitoring. The communications device 50 is turned on and connected through a communications network to establish a communicative interconnection remotely with the remote device 18. The illumination device 52 is powered on and preferably left illuminated so that the internal compartment 24 of the case 20 is illuminated even when closed.

Any necessary configuration or set up of the air pressure monitor 54, alarm device 56 and camera 58 may be undertaken at this point. The air pressure monitor 54 should be tested to ensure proper operation. The camera 58 will be activated with its lens 59 pointing directly at the air pressure monitor 54. The air compressor 12 may then be turned on to initiate the pipe lining process. The air compressor will direct air pressure through the pipe liner 14.

Preferably, the air pressure monitor 54 will initially be viewed to ensure proper operation. The alarm device 56 may be tested by disconnecting power during operation to ensure that an alarm is properly initiated upon loss of power. Further initial testing may be undertaken by disconnecting the port 40 or powering off the air compressor 12 to ensure that an alarm is initiated upon loss of pressure. The case 20 may then be closed by securing the cover 22 to the base 20. The present invention may then be left to operate, with the operator free to travel to any remote location.

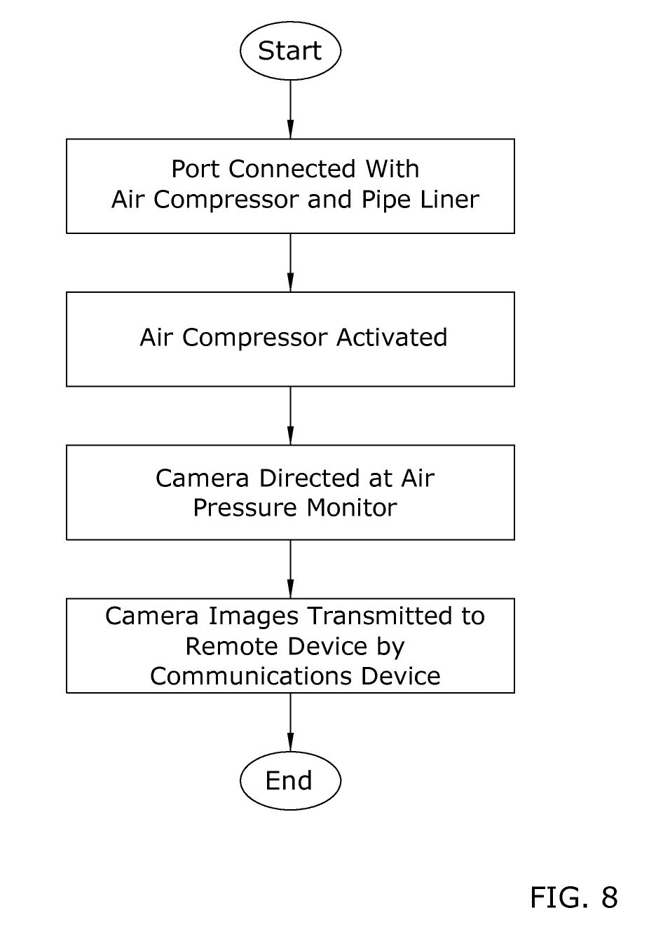

During operation of the lining process, the present invention will continuously monitor the pressure and power to ensure proper functionality. FIG. 8 illustrates the initial setup and video monitoring functionalities of the present invention. When operating, the camera 58 will continuously point at the air pressure monitor 54 so that, at any time, the remote device 18 may establish connectivity with the communications device 50 to receive still or moving images of the air pressure monitor 54.

Using this functionality, a technician may periodically check up on operation of the present invention to ensure that no alerts were missed and that everything is functioning properly. It should be appreciated that the camera 58 may, in some embodiments, be adapted to continuously transmit such images at all times that the present invention is active. In other embodiments, the camera 58 will only transmit such images upon request by the technician, such as via the remote device 18. The latter configuration may aid in reduction of power consumption by the present invention.

FIG. 9 illustrates a flow chart of an exemplary response by the present invention to a loss of power to the power source 30. In the event that the power source 30 loses power, it will preferably seamlessly transfer to a backup power source, such as a battery backup or through using an uninterruptible power supply to ensure minimal loss of operation.

The alarm device 56 will activate and emit an audible alarm to indicate that power has been lost. The audio detector 57 of the present invention will detect the audible alarm. The communications device 50 may then activate to transmit an alert to the remote device 18 that the power has been lost. As previously mentioned, the alert may comprise various forms of communication, including text messages, phone calls, emails, instant messages, and the like. Upon receipt of the alert, the technician will be notified of the conditions so that any problems may be addressed.

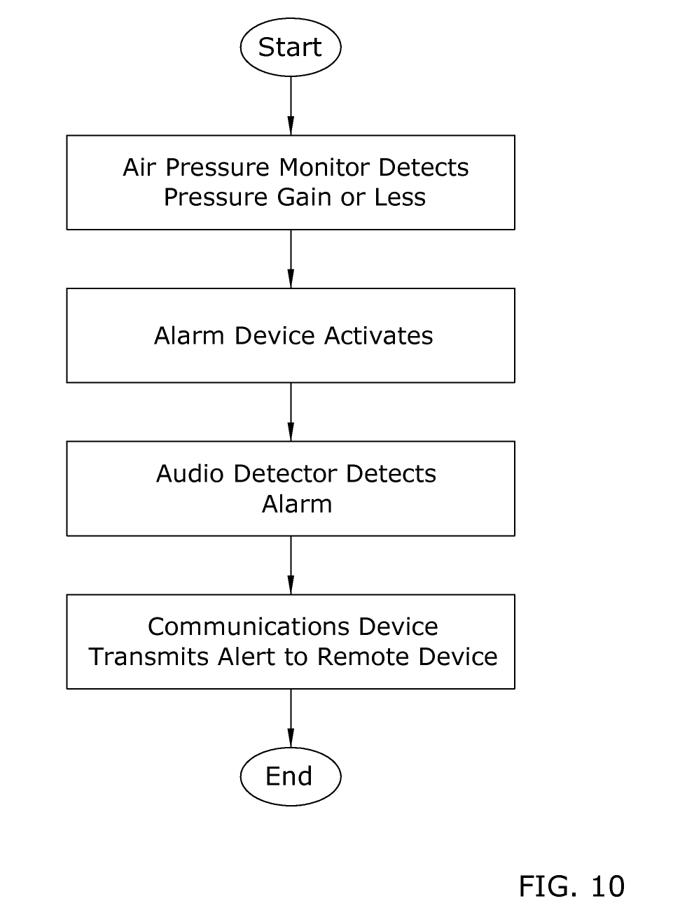

FIG. 10 illustrates a flow chart of an exemplary response by the present invention to an unexpected change in pressure (loss or gain). The loss of pressure during lining operations can be extremely detrimental to the curing process, and may require that the entire lining process be restarted. Thus, it is important that any change in pressure be effectively and promptly transmitted to the technician so that conditions may be addressed.

The alarm device 56 will activate and emit an audible alarm to indicate an unexpected change in pressure detected by the air pressure monitor 54. The alarm emitted due to loss of pressure may be distinct from that which is emitted due to loss of power so that the audio detector 57 can distinguish between the two conditions. In other embodiments, the audio detector 57 may utilize other methods to distinguish between the conditions. In some embodiments, separate audio devices 56 may be utilized for the power source 30 and the air pressure monitor 54, respectively, such that different audio devices 56 are being activated for each condition.

Upon detection of the audible alarm by the audio detector 57, the communications device 50 will activate to transmit an alert to the remote device 18 that the pressure has changed. Any type of alert may be initiated, such as those which have been previously outlined herein. In response to the alert, the technician will be given the opportunity to quickly address the situation without having to constantly monitor the lining process on-site.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described above. All publications, patent applications, patents, and other references mentioned herein are incorporated by reference in their entirety to the extent allowed by applicable law and regulations. The present invention may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

The invention claimed is:

1. A remote pipe lining air monitoring system, comprising:
a port adapted to be connected in-line between an air compressor and a pipe liner;
an air pressure monitor connected to said port;
an alarm device adapted to emit an alarm in the event of an unexpected change in air pressure;
an audio detector adapted to detect said alarm; and
a communications device adapted to transmit an alert to a remote device.

2. The remote pipe lining air monitoring system of claim 1, further comprising a camera directed at said air pressure monitor.

3. The remote pipe lining air monitoring system of claim 2, wherein said audio detector is integrated with said camera.

4. The remote pipe lining air monitoring system of claim 3, wherein said audio detector is comprised of a microphone.

5. The remote pipe lining air monitoring system of claim 2, said communications device being adapted to transmit one or more images of said air pressure monitor from said camera to said remote device.

6. The remote pipe lining air monitoring system of claim 1, further comprising a power supply.

7. The remote pipe lining air monitoring system of claim 6, wherein said power supply is comprised of an uninterruptible power supply.

8. The remote pipe lining air monitoring system of claim 6, wherein said alarm device is adapted to emit said alarm in the event of loss of power by said power supply.

9. The remote pipe lining air monitoring system of claim 1, wherein said alert is comprised of a text message.

10. The remote pipe lining air monitoring system of claim 1, wherein said alarm is comprised of an audible alarm.

11. The remote pipe lining air monitoring system of claim 1, wherein said remote device comprises a smart phone.

12. A remote pipe lining air monitoring system, comprising:
a case;
a port extending from said case, said port being adapted to connect in-line between an air compressor and a pipe liner;
an air pressure monitor connected to said port;
a power supply;
at least one alarm device adapted to emit at least one alarm in the event of an unexpected change in air pressure, said at least one device being further adapted to emit said at least one alarm in the event of loss of power by said power supply;
an audio detector adapted to detect said alarm; and
a communications device adapted to transmit an alert to a remote device.

13. The remote pipe lining air monitoring system of claim 12, wherein said at least one alarm device comprises a first alarm device for said air pressure monitor and a second alarm device for said power supply.

14. The remote pipe lining air monitoring system of claim 12, wherein said at least one alarm comprises a first alarm for said air pressure monitor and a second alarm for said power supply.

15. The remote pipe lining air monitoring system of claim 12, wherein said communications device comprises a wireless router.

16. The remote pipe lining air monitoring system of claim 12, further comprising a camera directed at said air pressure monitor.

17. The remote pipe lining air monitoring system of claim 16, wherein said audio detector is integrated with said camera.

18. The remote pipe lining air monitoring system of claim 16, said communications device being adapted to transmit one or more images of said air pressure monitor from said camera to said remote device.

19. The remote pipe lining air monitoring system of claim 12, further comprising an illumination device positioned within said case.

20. A remote pipe lining air monitoring system, comprising:
a case including a base and a cover hingedly connected to said base;
a port extending from said case, said port including an inlet and an outlet, said port being adapted to connect in-line between an air compressor and a pipe liner;
an uninterruptible power supply;
an illumination device positioned within said case;
a first alarm device adapted to emit a first alarm in the event of an unexpected change in air pressure;
a second alarm device adapted to emit a second alarm in the event of loss of power by said power supply;
an audio detector adapted to detect said first alarm and said second alarm;
a camera positioned within said case, said camera being directed at said air pressure monitor; and
a communications device adapted to transmit a first alert to a remote device upon detection of said first alarm and a second alert to said remote device upon detection of said second alarm, said communications device being further adapted to continuously transmit one or more images of said air pressure monitor from said camera to said remote device.
